(19) United States
(12) Patent Application Publication
(10) Pub. No.: US 2019/0113761 A1
(43) Pub. Date: Apr. 18, 2019

(54) BEAM EXPANDER AND DISPLAY INCLUDING THE SAME

(71) Applicant: SAMSUNG ELECTRONICS CO., LTD., Suwon-si (KR)

(72) Inventors: Sunil KIM, Seoul (KR); Chilsung CHOI, Suwon-si (KR); Hoon SONG, Yongin-si (KR); Jungkwuen AN, Suwon-si (KR); Sunghoon LEE, Seoul (KR)

(73) Assignee: SAMSUNG ELECTRONICS CO., LTD., Suwon-si (KR)

(21) Appl. No.: 15/937,288

(22) Filed: Mar. 27, 2018

(30) Foreign Application Priority Data
Oct. 13, 2017 (KR) 10-2017-0133481

(51) Int. Cl. G02B 27/09; G02B 27/30; F21V 8/00

(52) U.S. Cl. CPC G02B 27/0944; G02B 27/30; G02B 27/0916; G02B 6/0051; G02B 6/0038; G02B 6/005; G02B 6/0016

(57) ABSTRACT

A beam expander and a displays including the beam expander are provided. The beam expander includes a holographic optical element (HOE) configured to generate collimated light by diffracting incident light incident thereon from a light source that emits coherent light. The beam expander also includes a diffraction optical element that diffracts light received from the HOE. The light source and the HOE may face each other with the diffraction optical element therebetween. Both the light source and the HOE may be arranged on a side of the diffraction optical element. The light source may be arranged above or below the diffraction optical element.

### CROSS-REFERENCE TO RELATED APPLICATION

This application claims priority from Korean Patent Application No. 10-2017-0133481, filed on Oct. 13, 2017, in the Korean Intellectual Property Office, the disclosure of which is incorporated herein in its entirety by reference.

### BACKGROUND

### 1. Field

Apparatuses consistent with exemplary embodiments relate to displays, and more particularly, to beam expanders and flat panel displays including the same.

### 2. Description of the Related Art

A related art beam expander includes a collimator that collimates light emitted from a light source and a diffraction grating that diffracts the collimated light and directs it to a desired direction. The collimator is often a lens optical system including a plurality of lenses, such as a lens for expanding, to a certain size, a width of a beam emitted from the light source, and a lens for collimating the expanded light. These lenses are often arranged at a certain distance from each other and may be aspherical lenses.

### SUMMARY

One or more exemplary embodiments may provide slim and compact beam expanders.

One or more exemplary embodiments may provide displays including the beam expanders.

Additional exemplary aspects and advantages will be set forth in part in the description which follows and, in part, will be apparent from the description, or may be learned by practice of the presented embodiments.

According to an aspect of an exemplary embodiment, a beam expander includes: a light source configured to emit coherent light; a holographic optical element (HOE) configured to generate collimated light by diffracting light received from the light source; and a diffraction optical element configured to diffract the light received from the HOE toward a given direction.

The light source and the HOE may face each other with the diffraction optical element disposed therebetween.

Both the light source and the HOE may be arranged on a side of the diffraction optical element.

The light source may be arranged above or below the diffraction optical element.

The HOE may include a hologram layer including an interference pattern configured to generate light having a plane wave front that is diffracted toward the diffraction optical element, such that the light is incident on the diffraction optical element at an acute angle with respect to the diffraction optical element.

The HOE may include a waveguide, a first HOE attached to a side of the waveguide, and a second HOE attached to a side of the waveguide and spaced apart from the first HOE.

The HOE may be of a reflection type HOE or a transmission type HOE.

The light source may include a coherent light source and an optical fiber.

The diffraction optical element may be a grating or an HOE. The grating may include one of a binary grating, a blazed grating, and a sinusoidal grating.

The given angle with respect to the diffraction optical element may be less than an angle at which light incident on the diffraction optical element is totally reflected.

One of the first HOE and the second HOE may be of a reflection type and the other one may be of a transmission type.

The acute angle with respect to the diffraction optical element normal line may be greater than 0° and less than or equal to 10°.

According to an aspect of another exemplary embodiment, a display includes a light expanding unit and a beam expander as described above and configured to supply coherent light to the light expanding unit.

### BRIEF DESCRIPTION OF THE DRAWINGS

These and/or other exemplary aspects will become apparent and more readily appreciated from the following description of exemplary embodiments, taken in conjunction with the accompanying drawings in which:

FIG. 1 is a schematic cross-sectional view of a holographic display according to an exemplary embodiment;

FIG. 2 is a cross-sectional view of the beam expander of FIG. 1;

FIG. 3 is a plan view of the beam expander of FIG. 2 seen from a y-axis direction;

FIG. 4 is a cross-sectional view of a beam expander according to another exemplary embodiment;

FIG. 5 is a cross-sectional view of a beam expander according to another exemplary embodiment;

FIG. 6 is a perspective view of a flat panel display according to an exemplary embodiment; and

FIG. 7 is a cross-sectional view of the flat panel display of FIG. 6 including the beam expander of FIG. 2.

### DETAILED DESCRIPTION

Beam expanders according to exemplary embodiments and displays including the beam expanders will now be described in detail with reference to the accompanying drawings. In the drawings, thicknesses of layers or regions may be exaggerated for clarity.

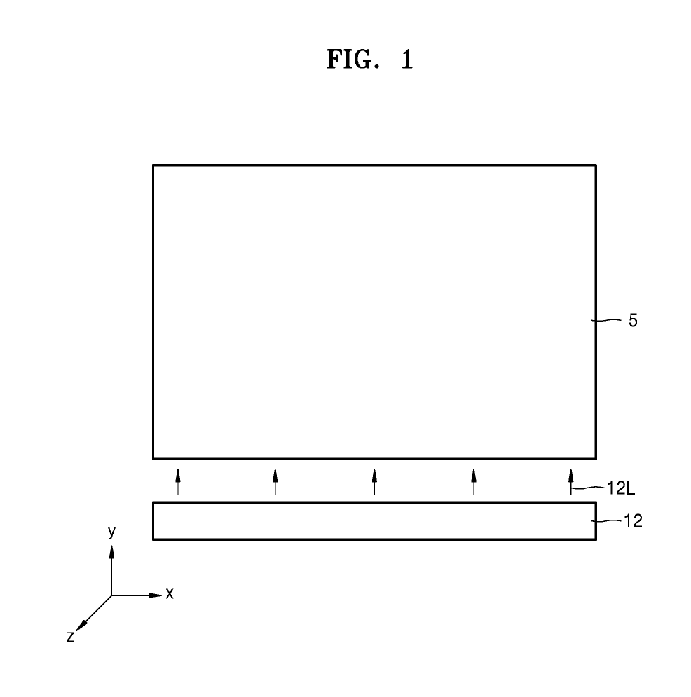

FIG. 1 shows a flat panel display (FPD) including a beam expander according to an exemplary embodiment.

Referring to FIG. 1, the FPD includes a display unit 5 and a beam expander 12. The FPD may be a display that uses coherent light. For example, the display may be a holographic display. The display unit 5 may be referred to as a main body of the FPD. In detail, the display unit 5 may comprise all of the FPD except for the beam expander 12. Accordingly, the display unit 5 may include a unit on which an image is displayed. The image may be a 2-dimensional (2D) image or a three-dimensional (3D) image. The display unit 5 may include a plurality of elements including with a light diffuser. The light diffuser may receive light 12L emitted from the beam expander 12. The light diffuser may be configured to uniformly supply light to an entire surface of a device located in front of the light diffuser by diffusing light received from the beam expander 12. For example, the light diffuser may include a waveguide. The light 12L supplied to the display unit 5 from the beam expander 12 may be coherent light. The beam expander 12 may be spaced apart from the light diffuser of the display unit 5 or may directly contact the light diffuser of the display unit 5. When the beam expander 12 is spaced apart from the light diffuser, a medium or an element that allows the beam expander 12 to indirectly contact the light diffuser may be arranged between the beam expander 12 and the light diffuser.

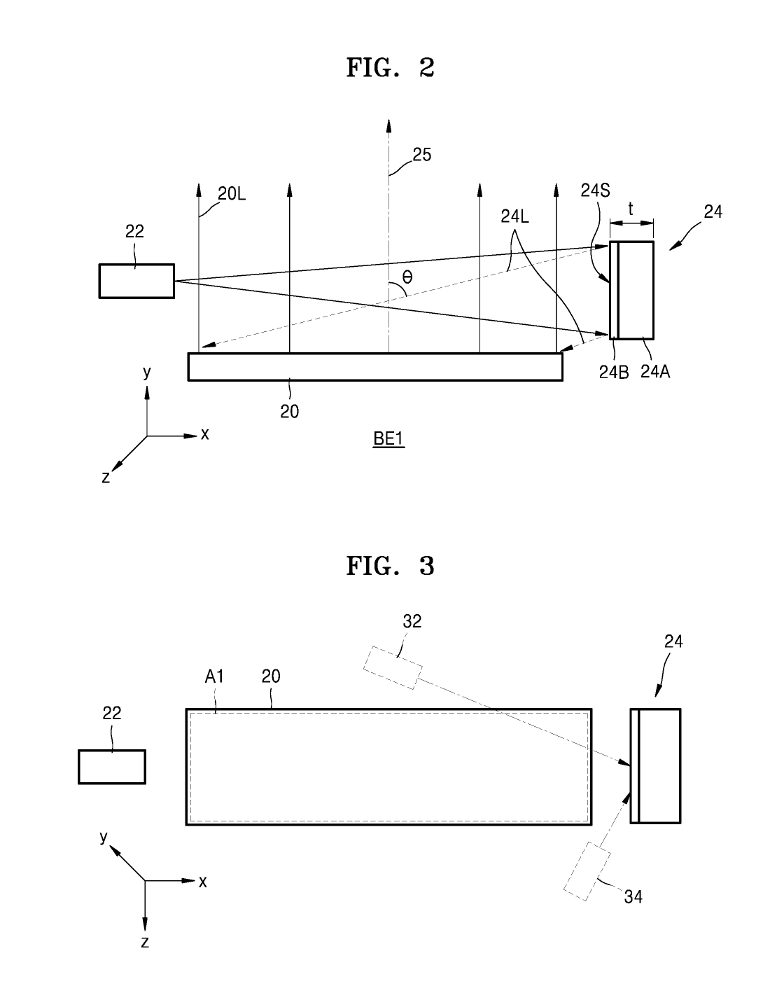

FIG. 2 is a cross-sectional view of the beam expander 12 of FIG. 1.

Referring to FIG. 2, a beam expander BE1 includes a diffraction optical element 20, a light source 22, and a holographic optical element (HOE) 24. The light source 22 and the HOE 24 may be arranged on opposite sides of the diffraction optical element 20. However, the arrangement described above is merely exemplary, and may vary according to the will of a manufacturer. The light source 22, the diffraction optical element 20, and the HOE 24 may be mutually spaced apart from each other. The light source 22 and the HOE 24 may be arranged to face each other with the diffraction optical element 20 therebetween. The diffraction optical element 20 and the HOE 24 may be arranged substantially perpendicularly to each other. For example, the diffraction optical element 20 may be aligned in an x-z plane , and the HOE 24 may be aligned in a y-z plane, as shown in FIG. 2. The light source 22 may emit coherent light. As an example, the light source 22 may include an optical element that emits a laser. The light source 22 may also include an optical fiber. The optical fiber may be an element that transmits the emitted laser to a determined location. The optical element included in the light source 22 may be, for example, a laser diode (LD). Elements (for example, an LD and an optical fiber) included in the light source 22 may be arranged so that the emitted coherent light is in the form of a symmetric diverging beam. The HOE 24 changes a progressing direction of light incident thereon and also changes the wave front of the light to into a plane. That is, the HOE 24 modifies and diffracts the light incident thereon, such that light emitted from the HOE is collimated and directed to the diffraction optical element 20. The HOE 24 includes a substrate 24A and a hologram layer 24B disposed on the substrate 24A. The hologram layer 24B may face the light source 22. A surface 24S of the hologram layer 24B through which light enters may be perpendicular to a light emission surface of the diffraction optical element 20. That is, a line normal to the surface 24S of the hologram layer 24B through which light enters and a line 25 normal to a surface of the diffraction optical element 20 through which light is emitted are perpendicular to each other. The HOE 24 is a reflective type optical element. The hologram layer 24B may include an interference pattern by which light is emitted in a specific direction when a reference light, used for forming the hologram layer 24B, is irradiated onto the hologram layer 24B. The interference pattern is recorded in the hologram layer 24B in the process of manufacturing the hologram layer 24B, using the reference light.

A method of forming a hologram is generally well known in the art, and thus, the description thereof will be omitted.

Light incident onto the hologram layer 24B from the light source 22 may be the reference light. When the coherent reference light is incident on the hologram layer 24B from the light source 22, the interference pattern recorded in the hologram layer 24B acts as a diffraction grating, and thus, diffraction light 24L, emitted in a direction different from the incident direction of the reference light, is generated. The diffraction light 24L corresponds to signal light, used together with the reference light, in the formation of the hologram and is one-dimensionally expanded collimated light. The one-dimensionally expanded collimated light 24L, generated by the HOE 24 according to the irradiation of the reference light, is incident on the diffraction optical element 20 at an angle. For example, the collimated light 24L generated by the HOE 24 may be incident on the diffraction optical element 20 at an angle θ with respect to the line 25 that is normal to a surface of the diffraction optical element 20. The angle θ is less than an angle at which incident light is totally reflected from the diffraction optical element 20. The angle θ may be, for example, equal to or greater than 80° and less than 90°. As described above, as the collimated light 24L generated from the HOE 24 is incident on the diffraction optical element 20 at an angle, the collimated light 24L may be incident between one side and another side of the diffraction optical element 20. Accordingly, the collimated light may be incident on an entire surface between the one side and the other side of the diffraction optical element. The collimated light 24L incident on the diffraction optical element 20 is diffracted toward a perpendicular direction with respect to the diffraction optical element 20, that is, toward a direction parallel to the line 25, due to a diffraction characteristic of the diffraction optical element 20. In this way, one-dimensionally uniformly expanded light 20L is incident on the display unit 5 (refer to FIG. 1) and is used for displaying an image. The diffraction optical element 20 may be a grating or an HOE. The grating may be a reflective type grating, a binary grating, a blazed grating, or a sinusoidal grating.

The HOE 24, arranged on an optical path between the light source 22 and the diffraction optical element 20, does not include any lens optical system, as used in the related art, and has a thickness t, for example, of approximately 2 mm. In contrast, in place of the HOE, a beam expander of the related art uses a lens optical system including a plurality of lenses, such as a lens for beam expanding and a collimating lens, and thus, the related art beam expander has a total thickness in a range from about 40 mm to about 50 mm. Accordingly, the thickness of the HOE of the present exemplary embodiment is about 1/20th of the thickness of the corresponding lens optical system of the related art. Therefore, when a beam expander according to an exemplary embodiment is used, a much more slim and compact beam expander may be realized, as compared to a beam expander of the related art. Accordingly, when a beam expander of and exemplary embodiment is used in a display (for example, a tablet personal computer), the display may be comparatively more slim and compact.

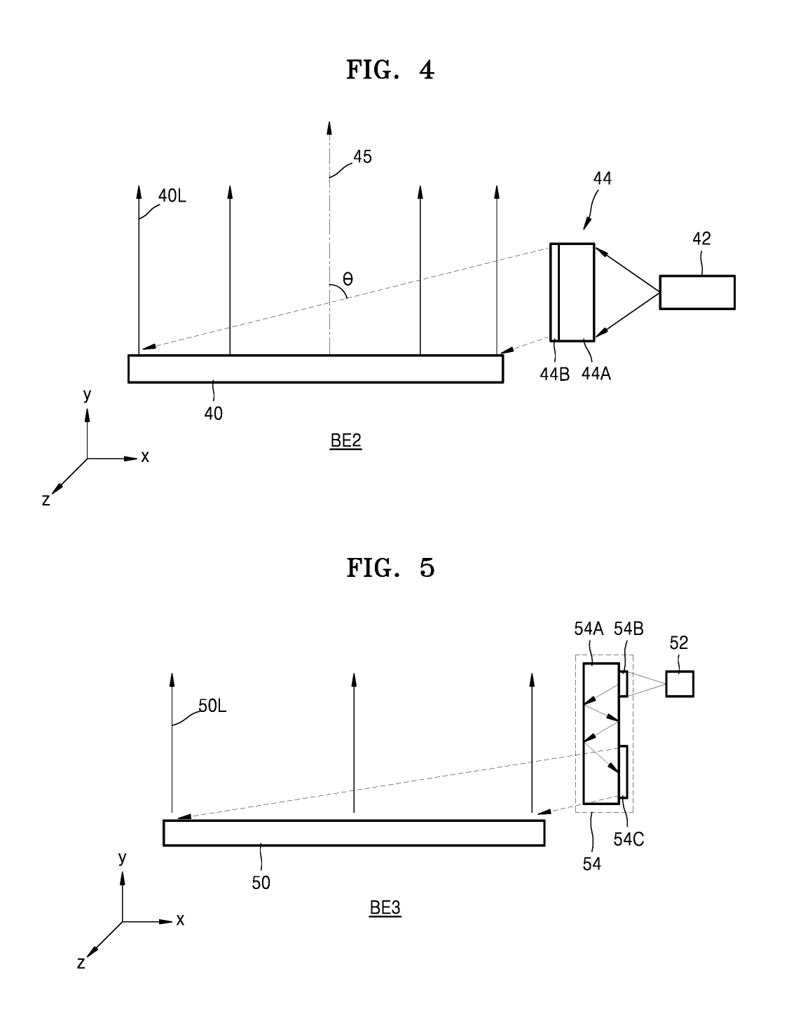

FIG. 3 is a plan view of the beam expander of FIG. 2 seen from a y-axis direction (a display unit 5 of FIG. 1).

Referring to FIG. 3, as viewed from the y-axis direction, the diffraction optical element 20 is arranged between the light source 22 and the HOE 24. Reference numeral A1 indicates a light emission region of the diffraction optical element 20. The light source 22 may alternately be arranged at another location. For example, as indicated by a reference numeral 32, the light source 22 may be arranged toward a front side of the diffraction optical element 20, or as indicated by a reference numeral 34, the light source 22 may be arranged toward a rear side of the diffraction optical element 20.

FIG. 4 is a cross-sectional view of a beam expander BE2 according to another exemplary embodiment. The beam expander BE2 may be used as the beam expander 12 of FIG. 1.

Referring to FIG. 4, the beam expander BE2 includes a diffraction optical element 40, a light source 42, and a HOE 44. Both the HOE 44 and the light source 42 may be arranged on a same side of the diffraction optical element 40, as shown. The HOE 44 may be arranged on an optical path between the light source 42 and the diffraction optical element 40. The HOE 44 is a transmitting type element. Light from the light source 42, arranged behind the HOE 44, is incident on a hologram layer 44B after being transmitted through the substrate 44A. Light incident on the hologram layer 44B is changed into one-dimensionally expanded collimated light by being diffracted by an interference pattern recorded in the hologram layer 44B, and the collimated light is incident on the diffraction optical element 40 at an angle θ with respect to a line 45 normal to a light emission surface of the diffraction optical element 40. Characteristics of the incident angle θ may be the same as the characteristics of the incident angle θ of FIG. 2, discussed above. Diffraction characteristics of the HOE 44 may be generated in the process of manufacturing the hologram layer 44B of the HOE 44. Light incident on the diffraction optical element 40 is diffracted in a direction substantially perpendicular to the diffraction optical element 40 by the diffraction characteristics of the diffraction optical element 40 and thus is incident on display unit 5 from the direction substantially normal to a surface of the display unit 5 (refer to FIG. 1). The diffraction characteristics of the diffraction optical element 40 may be determined according to the process of manufacturing the diffraction optical element 40. The performance of the HOE 44 may be the same as the performance of the HOE 24 described with reference to FIG. 2. Also, the configurations and performances of the diffraction optical element 40 and the light source 42 may be respectively the same as those of the diffraction optical element 20 and the light source 22 described with reference to FIG. 2.

FIG. 5 is a cross-sectional view of a beam expander BE3 according to another exemplary embodiment.

Referring to FIG. 5, the beam expander BE3 includes a diffraction optical element 50, an HOE 54, and a light source 52 that emits coherent light. The configurations of the diffraction optical element 50 and the light source 52 may be, for example, the same as those of the diffraction optical element 20 and the light source 22 described with reference to FIG. 2. The HOE 54 may be arranged on an optical path between the light source 52 and the diffraction optical element 50. The function of the HOE 54 may be the same as that of the HOE 24 or 44 of the beam expanders BE1 and BE2 described above. That is, the HOE 54 receives light emitted from the light source 52 and provides one-dimensionally expanded collimated light to the diffraction optical element 50. The diffraction optical element 50 diffracts the received collimated light and generates light 50L that is emitted in a direction (y-axis direction) perpendicular to the diffraction optical element 50.

The HOE 54 includes a waveguide 54A, a first HOE 54B, and a second HOE 54C. The waveguide 54A may be aligned in a y-z plane, perpendicular to the diffraction optical element 50. The first and second HOEs 54B and 54C may be arranged between the waveguide 54A and the light source 52. The first and second HOEs 54B and 54C are attached to a surface of the waveguide 54A. For example, the first and second HOEs 54B and 54C are attached to a surface of the waveguide 54A facing the light source 52. The first HOE 54B may be a transmission type HOE. The light source 52 may be or may not be arranged on a location facing the first HOE 54B. Light emitted from the light source 52 enters the first HOE 54B, and is diffracted at an angle into the waveguide 54A. The light diffracted into the waveguide 54A is incident on the second HOE 54C through total reflection. The second HOE 54C is separated from the first HOE 54B. The second HOE 54C may be arranged at a location that diffracts light incident thereon via the waveguide 54A and from which the diffracted light is made incident onto the diffraction optical element 50 at an incident angle. Accordingly, the second HOE 54C may be a reflection type HOE.

When light emitted from the light source 52 is transmitted into the waveguide 54A while maintaining its coherency, the first HOE 54B may be omitted.

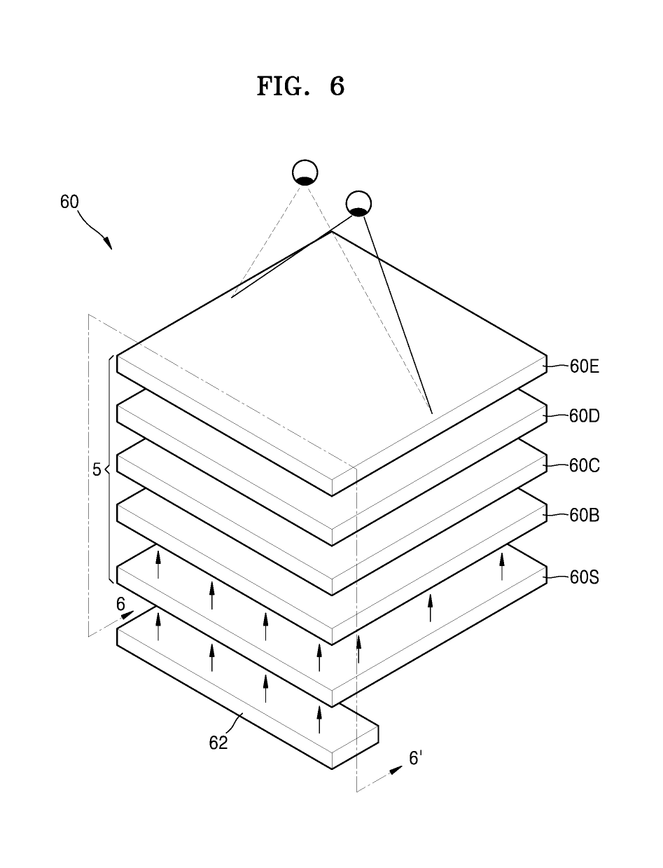

FIG. 6 is a perspective view of a flat panel display 60 including a beam expander 62 according to an exemplary embodiment. The flat panel display 60 of FIG. 6 may be a holographic display.

Referring to FIG. 6, the flat panel display 60 may include the beam expander 62 and a light diffusing unit 60S, a first beam deflection unit 60B, a second beam deflection unit 60C, a lens unit 60D, and a light modulation unit 60E that are sequentially stacked above the beam expander 62. The light diffusing unit 60S, the first beam deflection unit 60B, the second beam deflection unit 60C, the lens unit 60D, and the light modulation unit 60E may be exemplary elements included in the display unit 5 of FIG. 1. FIG. 1 may be a cross-sectional view taken along a line 6-6′ of FIG. 6. The light diffusing unit 60S may be configured to uniformly diffuse light incident thereon from the beam expander 62, and transmitted to an entire bottom surface of the first beam deflection unit 60B, and may include, for example, a waveguide. The light modulation unit 60E may include a spatial light modulator. The first beam deflection unit 60B may include a first beam steerer configured to deflect incident light. The second beam deflection unit 60C may include a second beam steerer configured to deflect incident light. The beam expander 62 is arranged below the light diffusing unit 60S. The beam expander 62 may be arranged under the light diffusing unit 60S to face a part of a bottom surface of the light diffusing unit 60S. The beam expander 62 may be arranged in a location such that light emitted from the beam expander 62 enters the portion of the bottom surface of the light diffusing unit 60S, facing the beam expander 62, at a normal angle. The beam expander 62 and the light diffusing unit 60S may contact or may not contact each other. If the beam expander 62 is spaced apart from the light diffusing unit 60S, h an optical transmission medium may be disposed therebetween.

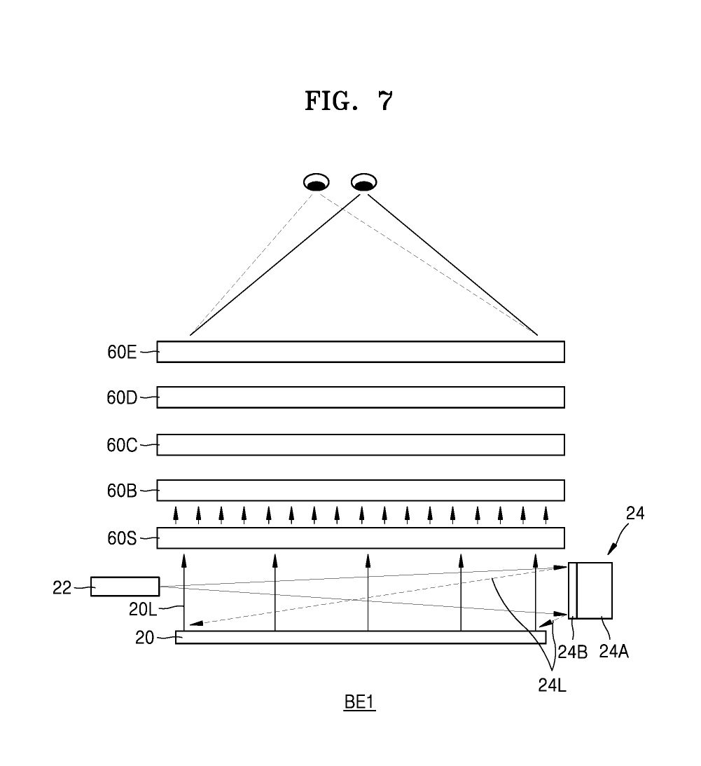

The beam expander 62 may be one of the beam expanders BE1 through BE3 described with reference to FIGS. 2, 4, and 5. As an example, FIG. 7 shows a case in which the beam expander 62 is the beam expander BE1 depicted in FIG. 2.

While one or more exemplary embodiments have been described with reference to the figures, it will be understood by those of ordinary skill in the art that various changes in form and details may be made therein without departing from the spirit and scope as defined by the following claims.

What is claimed is:

1. A beam expander comprising:
a light source configured to emit coherent light;
a holographic optical element (HOE) configured to generate collimated light by diffracting light received from the light source; and
a diffraction optical element configured to diffract the light received from the HOE.

2. The beam expander of claim 1, wherein an output of the light source faces a light incident surface of the HOE face each other, and the diffraction optical element is disposed between the light source and the HOE.

3. The beam expander of claim 1, wherein the light source and the HOE are arranged on a same side of the diffraction optical element.

4. The beam expander of claim 1, wherein the HOE comprises a hologram layer comprising an interference pattern configured to generate a plane wave that is incident on the diffraction optical element at an acute angle with respect to the diffraction optical element.

5. The beam expander of claim 1, wherein the HOE comprises:
a waveguide;
a first HOE attached to a side of the waveguide; and
a second HOE attached to the side of the waveguide and spaced apart from the first HOE.

6. The beam expander of claim 1, wherein the HOE is a reflection type HOE.

7. The beam expander of claim 1, wherein the HOE is a transmission type HOE.

8. The beam expander of claim 1, wherein the light source comprises a coherent light source and an optical fiber.

9. The beam expander of claim 1, wherein the diffraction optical element is one of a grating and an HOE.

10. The beam expander of claim 4, wherein the acute angle is less than an angle at which light is totally reflected from the diffraction optical element.

11. The beam expander of claim 5, wherein the first HOE is a reflection type HOE and the second HOE is a transmission type HOE.

12. The beam expander of claim 10, wherein the acute angle is greater than 0° and less than or equal to 10°.

13. The beam expander of claim 1, wherein the light source is arranged so that light emitted from the light source is incident on the HOE at an acute angle with respect to the HOE.

14. The beam expander of claim 9, wherein the grating comprises one of a binary grating, a blazed grating, and a sinusoidal grating.

15. A display comprising a light diffusing unit and the beam expander of claim 1, wherein the bean expander is configured to supply coherent light to the light diffusing unit.

16. A beam expander comprising:
a light source configured to emit coherent light;
a diffraction optical element configured to diffract light incident thereon and emit light in a direction normal to an emission surface of the diffraction optical element; and
a holographic optical element (HOE), disposed on an optical path between the light source and the diffraction optical element, wherein the HOE is configured to output collimated light toward the diffraction optical element.
